(19) United States
(12) Patent Application Publication
(10) Pub. No.: US 2026/0218496 A1
(43) Pub. Date: Jul. 30, 2026

(54) WORK MACHINE AND METHOD FOR INSPECTING HYDRAULIC OIL AMOUNT

(71) Applicant: KOMATSU LTD., Minato-ku, Tokyo (JP)

(72) Inventor: Kei SHINOHARA, Minato-ku, Tokyo (JP)

(73) Assignee: KOMATSU LTD., Minato-ku, Tokyo (JP)

(21) Appl. No.: 19/157,863

(22) PCT Filed: Feb. 27, 2024
(86) PCT No.: PCT/JP2024/007033

§ 371 Date: Aug. 19, 2025

(30) Foreign Application Priority Data
Mar. 7, 2023 (JP) 2023-034846

(51) Int. Cl. E02F 9/26; E02F 3/32; E02F 3/43; E02F 9/20; E02F 9/22; G01F 23/80

(52) U.S. Cl. CPC E02F 9/267; E02F 3/32; E02F 3/435; E02F 9/2037; E02F 9/226; E02F 9/265; G01F 23/80; E02F 9/2203

(57) ABSTRACT

Inspection of a hydraulic oil amount is efficiently performed. A work machine includes a vehicle body, a work implement supported by the vehicle body, a detection device that detects at least any one of an attitude of the vehicle body and an attitude of the work implement, and a controller. The controller executes a comparison in at least any one of the vehicle body and the work implement between a current attitude detected by the detection device and a target attitude at the time of maintenance set in advance, and outputs a result of the comparison.

### TECHNICAL FIELD

The present disclosure relates to a work machine and a method for inspecting a hydraulic oil amount.

### BACKGROUND ART

JP 2020-160777 A (Patent Document 1) describes that a cab front area including a front work implement is captured by a camera, a captured image of the cab front area captured by the camera and a target attitude image of the front work implement are displayed on a display, and the target attitude image is superimposed and displayed on a real front work implement on the captured image.

### CITATION LIST

### Patent Literature

Patent Document 1: JP 2020-160777 A

### SUMMARY OF INVENTION

### Technical Problem

At the time of pre-operation inspection of a work machine, the operator confirms the hydraulic oil amount in a hydraulic oil tank. In a known method for inspecting hydraulic oil, an operator boarding the cab of the work machine starts the engine, puts the work implement into a hydraulic oil inspection attitude, then stops the engine, and gets out of the cab to visually inspect the oil amount. Since this series of work takes time, the operator may feel annoyed.

The present disclosure proposes a technique capable of efficiently performing inspection of a hydraulic oil amount.

### Solution to Problem

A work machine according to a certain aspect of the present disclosure includes a vehicle body, a work implement supported by the vehicle body, a detection device that detects at least any one of an attitude of the vehicle body and an attitude of the work implement, and a controller. The controller executes a comparison in at least any one of the vehicle body and the work implement between a current attitude detected by the detection device and a target attitude at a time of maintenance set in advance, and outputs a result of the comparison.

A method for inspecting a hydraulic oil amount according to a certain aspect of the present disclosure is a method for inspecting a storage amount of hydraulic oil to be supplied to a work implement in a hydraulic oil tank that stores the hydraulic oil, and includes the following steps. The first step is to acquire a current attitude of the work implement. The second step is to execute a comparison in the work implement between the current attitude and a target attitude at a time of inspection set in advance. The third step is to, when a difference between the current attitude and the target attitude is smaller than a determination value, confirm as to whether the storage amount, of the hydraulic oil, that is current is appropriate. The fourth step is to output a result of the confirmation.

### Advantageous Effects of Invention

According to the present disclosure, it is possible to efficiently perform inspection of a hydraulic oil amount.

### BRIEF DESCRIPTION OF DRAWINGS

FIG. 1 is a side view schematically illustrating a configuration of a work machine.

FIG. 2 is a block diagram illustrating a system configuration of the work machine illustrated in FIG. 1.

FIG. 3 is a view illustrating a functional block of a controller.

FIG. 4 is a flowchart showing a flow of processing of inspecting a hydraulic oil amount.

FIG. 5 is a schematic diagram illustrating an example of display on a monitor when inspection of the hydraulic oil amount is started.

FIG. 6 is a schematic diagram illustrating an example of display on the monitor when a vehicle body is tilted.

FIG. 7 is a partial cross-sectional view illustrating a schematic configuration of a hydraulic cylinder.

FIG. 8 is a schematic diagram illustrating an example of display on the monitor when an arm and a bucket are out of target attitudes.

FIG. 9 is a schematic diagram illustrating an example of display on the monitor when the arm is out of the target attitude.

FIG. 10 is a schematic diagram illustrating an example of display on the monitor when the bucket is out of the target attitude.

FIG. 11 is a schematic diagram illustrating an example of display on the monitor when the arm and the bucket match the target attitudes.

FIG. 12 is an enlarged side view illustrating a vicinity of a distal end portion of the arm.

FIG. 13 is a schematic diagram illustrating an example of display on the monitor when a boom is above the target position.

FIG. 14 is a schematic diagram illustrating an example of display on the monitor when the boom is below the target position.

FIG. 15 is a schematic diagram illustrating an example of display on the monitor when the vehicle body and a work implement match the target attitudes.

FIG. 16 is a schematic diagram illustrating an example of display on the monitor when a storage amount of hydraulic oil in a hydraulic oil tank is small.

FIG. 17 is a flowchart showing a flow of operation when the work machine is stopped.

### DESCRIPTION OF EMBODIMENTS

With reference to the drawings, an embodiment is described below. In the following description, the same components and constituent elements are denoted by the same reference signs. The names and functions of these components are also the same. Accordingly, detailed descriptions thereof are not repeated. It is initially contemplated that any configuration may be extracted from the embodiment and combined in a freely-selected manner.

In the following description, “up”, “down”, “front”, “rear”, “left”, and “right” are directions based on an operator seated on an operator seat 2b in a cab 2a.

### Configuration of Work Machine

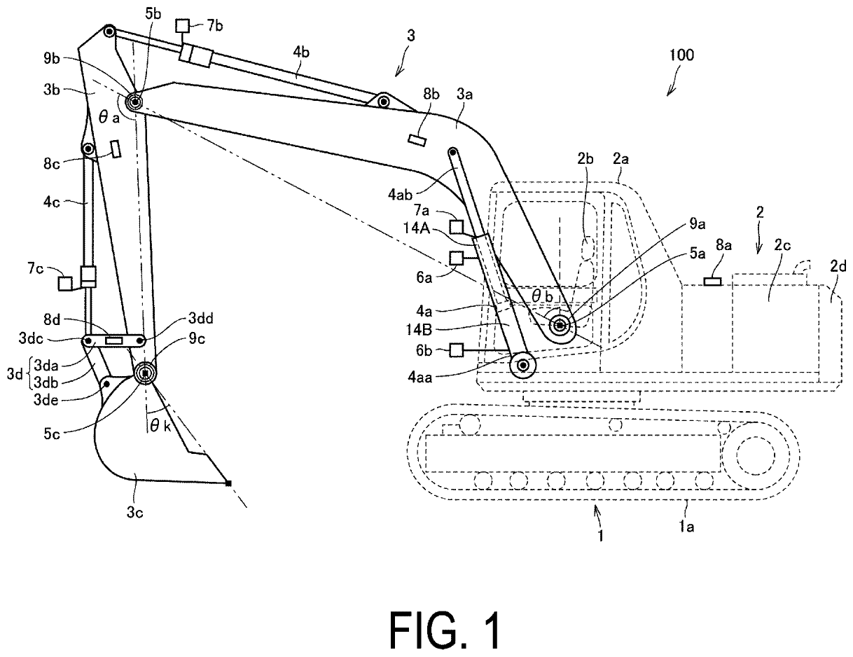

FIG. 1 is a side view schematically illustrating a configuration of a hydraulic excavator 100 as an example of a work machine in an embodiment. As illustrated in FIG. 1, the hydraulic excavator 100 of the present embodiment mainly includes a traveling body 1, a rotating body 2, and a work implement 3. The traveling body 1 and the rotating body 2 constitute a vehicle body of the hydraulic excavator 100.

The traveling body 1 includes a pair of left and right crawler track devices 1a. Each of the pair of left and right crawler track devices la includes a crawler track. When the pair of left and right crawler tracks are rotationally driven, the hydraulic excavator 100 self-travels.

The rotating body 2 is installed so as to be rotatable with respect to the traveling body 1. This rotating body 2 mainly includes a cab 2a, an operator seat 2b, an engine room 2c, and a counterweight 2d. The cab 2a is disposed, for example, on a front left side (a front side of a vehicle) of the rotating body 2. The operator seat 2b for an operator to be seated is disposed in an internal space of the cab 2a.

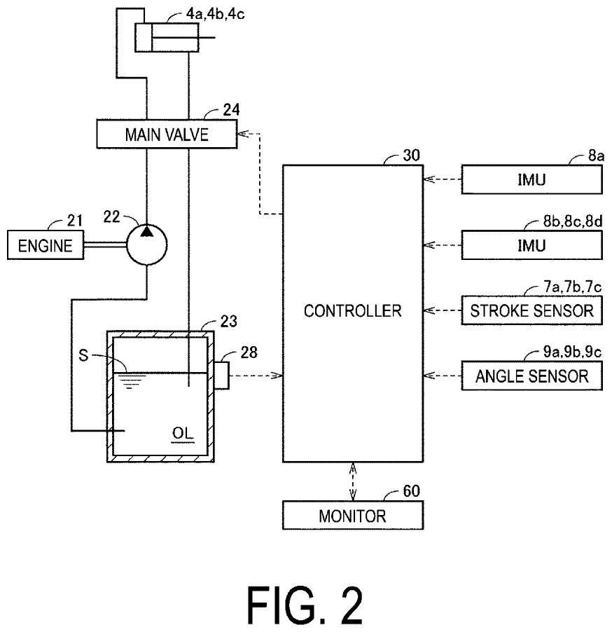

Each of the engine room 2c and the counterweight 2d is disposed on a rear side (vehicle rear side) of the rotating body 2 with respect to the cab 2a. The engine room 2c houses an engine unit (an engine 21 (FIG. 2), an exhaust treatment structure, and the like). The top of the engine room 2c is covered with an engine hood. The counterweight 2d is disposed at the rear of the engine room 2c.

The work implement 3 is supported by the rotating body 2 on a front side of the rotating body 2, for example, and on a right side of the cab 2a. The work implement 3 includes, for example, a boom 3a, an arm 3b, and bucket 3c. A base end portion of the boom 3a is rotatably coupled to the rotating body 2 by a boom foot pin 5a. A base end portion of the arm 3b is rotatably coupled to a distal end portion of the boom 3a by a boom top pin 5b. The bucket 3c is rotatably coupled to a distal end portion of the arm 3b by an arm top pin 5c.

The boom 3a can be driven by a boom cylinder 4a. By this driving, the boom 3a is rotatable in an up-down direction with respect to the rotating body 2 about the boom foot pin 5a. The arm 3b can be driven by an arm cylinder 4b. By this driving, the arm 3b is rotatable in the up-down direction with respect to the boom 3a about the boom top pin 5b. The bucket 3c can be driven by a bucket cylinder 4c. By this driving, the bucket 3c is rotatable in the up-down direction with respect to the arm 3b about the arm top pin 5c. In this way, the work implement 3 can be driven.

The work implement 3 includes a bucket link 3d. The bucket link 3d includes a first link member 3da and a second link member 3db. A tip of the first link member 3da and a tip of the second link member 3db are coupled to each other via a bucket cylinder top pin 3dc so as to be relatively rotatable. The bucket cylinder top pin 3dc is coupled to a tip of the bucket cylinder 4c. Therefore, the first link member 3da and the second link member 3db are pin-coupled to the bucket cylinder 4c.

A base end of the first link member 3da is rotatably coupled to the arm 3b by a first link pin 3dd. A base end of the second link member 3db is rotatably coupled to a bracket at a root portion of the bucket 3c by a second link pin 3de.

A head side of the boom cylinder 4a is attached with a pressure sensor 6a. The pressure sensor 6a can detect the pressure (head pressure) of the hydraulic oil in a cylinder head side oil chamber 14A of the boom cylinder 4a. A bottom side of the boom cylinder 4a is attached with a pressure sensor 6b. The pressure sensor 6b can detect the pressure (bottom pressure) of the hydraulic oil in a cylinder bottom side oil chamber 14B of the boom cylinder 4a.

The boom cylinder 4a, the arm cylinder 4b, and the bucket cylinder 4c are attached with stroke sensors 7a, 7b, and 7c, respectively. The stroke sensor 7a detects a displacement amount of a cylinder rod 4ab with respect to a cylinder 4aa in the boom cylinder 4a. The stroke sensor 7b detects a displacement amount of a cylinder rod in the arm cylinder 4b. The stroke sensor 7c detects a displacement amount of a cylinder rod in the bucket cylinder 4c.

Angle sensors 9a, 9b, and 9c may be attached around the boom foot pin 5a, the boom top pin 5b, and the arm top pin 5c, respectively. The angle sensors 9a, 9b, and 9c may be potentiometers or rotary encoders.

As illustrated in FIG. 1, in side view, an angle formed by a straight line passing through the boom foot pin 5a and the boom top pin 5b (illustrated by a two-dot chain line in FIG. 1) and a straight line extending in the up-down direction (indicated by a broken line in FIG. 1) is defined as a boom angle θb. The boom angle θb is generally an acute angle. The boom angle θb represents an angle of the boom 3a with respect to the rotating body 2. The boom angle θb can be calculated from a detection result of the stroke sensor 7a or can be calculated from a measurement value of the angle sensor 9a.

In side view, an angle formed by the straight line passing through the boom foot pin 5a and the boom top pin 5b and a straight line passing through the boom top pin 5b and the arm top pin 5c (illustrated by a two-dot chain line in FIG. 1) is defined as an arm angle θa. The arm angle Oa represents an angle of the arm 3b with respect to the boom 3a in a region where the arm 3b rotates in side view. The arm angle θa can be calculated from a detection result of the stroke sensor 7b or can be calculated from a measurement value of the angle sensor 9b.

In side view, an angle formed by the straight line passing through the boom top pin 5b and the arm top pin 5c and a straight line passing through the arm top pin 5c and a blade edge of the bucket 3c (illustrated by a two-dot chain line in FIG. 1) is defined as a bucket angle θk. The bucket angle Ok represents an angle of the bucket 3c with respect to the arm 3b in a region where the bucket 3c rotates in side view. The bucket angle θk can be calculated from a detection result of the stroke sensor 7c or can be calculated from a measurement value of the angle sensor 9c.

In addition, inertial measurement units (IMUs) 8a, 8b, 8c, and 8d are attached to the rotating body 2, the boom 3a, the arm 3b, and the first link member 3da, respectively. The IMU 8a measures accelerations of the rotating body 2 in a front-rear direction, a left-right direction, and the up-down direction, and angular velocities of the rotating body 2 around the front-rear direction, the left-right direction, and the up-down direction. The IMUs 8b, 8c, and 8d measure accelerations of the boom 3a, the arm 3b, and the first link member 3da in the front-rear direction, the left-right direction, and the up-down direction, and angular velocities of the boom 3a, the arm 3b, and the first link member 3da around the front-rear direction, the left-right direction, and the up-down direction, respectively.

Based on a difference between the acceleration measured by the IMU 8a attached to the rotating body 2 and the acceleration measured by the IMU 8b attached to the boom 3a, acceleration of extension and contraction of the boom cylinder 4a (a change amount in an extension/contraction speed of the boom cylinder 4a) can be acquired. The boom angle θb, the arm angle θa, and the bucket angle Ok may be calculated from the detection results of the IMUs 8b, 8c, and 8d, respectively.

The IMU 8a constitutes a vehicle body attitude sensor that is attached to the vehicle body of the work machine and detects the attitude of the vehicle body. The stroke sensors 7a, 7b, and 7c, the angle sensors 9a, 9b, and 9c, and the IMUs 8b, 8c, and 8d constitute work implement attitude sensors that are attached to the work implement 3 and detect the attitude of the work implement 3. The vehicle body attitude sensor and the work implement attitude sensors correspond to an example of the “detection device” that detects at least any one of the attitude of the vehicle body and the attitude of the work implement 3.

### Configuration of System

Next, a system configuration of the work machine will be described with reference to FIG. 2. FIG. 2 is a block diagram illustrating a system configuration of the work machine illustrated in FIG. 1. A broken line arrow in FIG. 2 indicates an electric circuit. Note that FIG. 2 illustrates only a part of a system constituting the hydraulic excavator 100 according to the embodiment.

The engine 21 is a drive source of the hydraulic excavator 100. The engine 21 is, for example, a diesel engine. The engine 21 includes a drive shaft for coupling to a hydraulic pump 22. The hydraulic pump 22 is coupled to a drive shaft of the engine 21. The hydraulic pump 22 is driven by the engine 21. The hydraulic pump 22 sucks and discharges the hydraulic oil accommodated in a hydraulic oil tank 23. The hydraulic oil discharged from the hydraulic pump 22 is supplied to various hydraulic actuators via a main valve 24. The hydraulic actuators include a rotating motor and a traveling motor that are not illustrated in addition to the boom cylinder 4a, the arm cylinder 4b, and the bucket cylinder 4c illustrated in FIG. 1.

The main valve 24 is controlled by a control command from a controller 30 to adjust a flow rate and a direction of the hydraulic oil to be supplied to the various hydraulic actuators. The operation of the hydraulic excavator 100 is controlled by controlling supply and emission of the hydraulic oil to and from the hydraulic actuators. The hydraulic oil is oil supplied to a hydraulic actuator in order to operate the hydraulic actuator. The hydraulic oil emitted from the hydraulic actuator is returned to the hydraulic oil tank 23 via the main valve 24.

Hydraulic oil OL is stored in the hydraulic oil tank 23. The hydraulic oil tank 23 is equipped on a rotating frame of the rotating body 2 (FIG. 1). The tilt angle of the vehicle body with respect to a horizontal plane includes the tilt angle of the hydraulic oil tank 23. The IMU 8a can detect the tilt angle of the hydraulic oil tank 23. An oil level S of the hydraulic oil OL stored in the hydraulic oil tank 23 fluctuates up and down along with supply and emission of the hydraulic oil to and from the hydraulic oil tank 23 or due to the tilt of the hydraulic oil tank 23.

The hydraulic oil tank 23 is provided with an oil amount sensor 28. The oil amount sensor 28 detects the amount of the hydraulic oil OL stored in the hydraulic oil tank 23. The oil amount sensor 28 detects the height of the oil level S of the hydraulic oil OL, for example. Oil amount data indicating the amount of the hydraulic oil OL detected by the oil amount sensor 28 is input to the controller 30. The oil amount sensor 28 is, for example, a level switch that can detect whether the oil level S is at a predetermined height or more, but may be a sensor of another specification.

A detection result of the attitude of the vehicle body detected by the IMU 8a is input to the controller 30. Detection results of the attitude of the work implement 3 detected by the IMUs 8b, 8c, and 8d, the stroke sensors 7a, 7b, and 7c, and the angle sensors 9a, 9b, and 9c are input to the controller 30.

The controller 30 is configured to include a central processing unit (CPU), a nonvolatile memory, and a timer. The controller 30 controls the operation of the hydraulic excavator 100 by executing a control program stored in the memory.

The controller 30 controls display content of a monitor 60. The monitor 60 is configured to be able to communicate with the controller 30. The monitor 60 displays various types of information by receiving input of a command signal from the controller 30. The information displayed on the monitor 60 may be, for example, information regarding the work executed by the hydraulic excavator 100, vehicle body information such as a fuel remaining amount, a cooling water temperature, and a hydraulic oil temperature, a captured image in which a periphery of the hydraulic excavator 100 is captured, and the like. The monitor 60 may be a touch panel, and in this case, an operation signal generated by the operator of the hydraulic excavator 100 touching a part of the monitor 60 is input from the monitor 60 to the controller 30.

The monitor 60 is disposed in the cab 2a. The monitor 60 may include a liquid crystal display, an organic EL display, or the like, and may be disposed so that the operator boarding the cab 2a can view a display screen. The monitor 60 may be attached to a right front pillar of the cab 2a, for example, with the display screen facing left rear. Alternatively, the monitor 60 may be a head-mounted display, a head-up display, or the like.

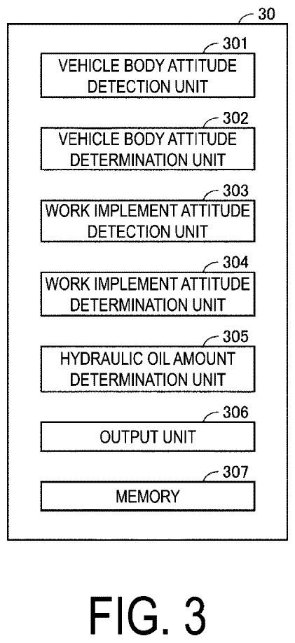

FIG. 3 is a view illustrating a functional block of the controller 30 of the hydraulic excavator 100 in the embodiment. As illustrated in FIG. 3, the controller 30 includes a vehicle body attitude detection unit 301, a vehicle body attitude determination unit 302, a work implement attitude detection unit 303, a work implement attitude determination unit 304, a hydraulic oil amount determination unit 305, an output unit 306, and a memory 307.

The memory 307 stores a program for controlling the operation of the hydraulic excavator 100 and various data necessary for execution of the program. The memory 307 also temporarily stores working data generated along with the operation of the hydraulic excavator 100.

### Inspection of Hydraulic Oil Amount at Start Inspection

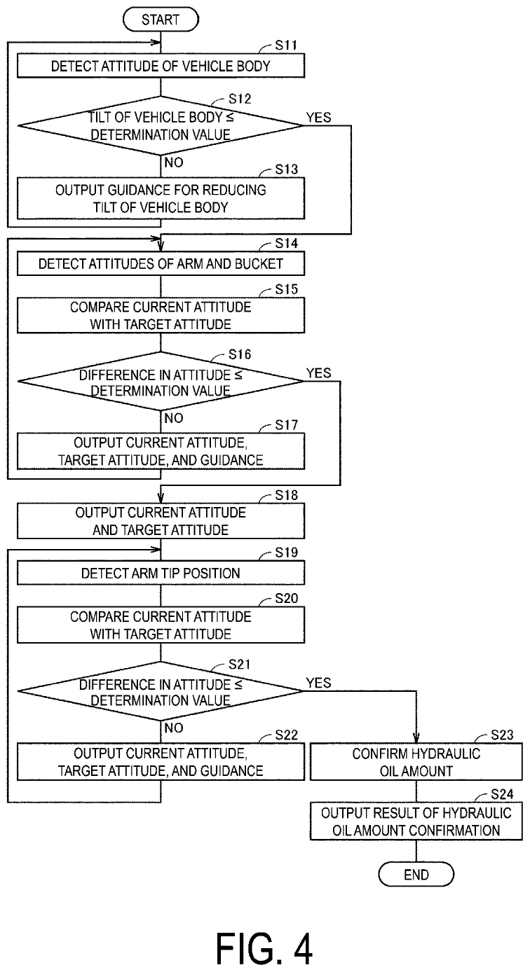

FIG. 4 is a flowchart showing a flow of processing of inspecting the hydraulic oil amount in the hydraulic excavator 100 in the embodiment. Processing in a case of automating inspection of the storage amount of the hydraulic oil OL in the hydraulic oil tank 23, which is performed as an item of the pre-operation inspection of the hydraulic excavator 100, will be described with reference to FIGS. 3 and 4 and subsequent drawings as appropriate.

When the storage amount of the hydraulic oil OL in the hydraulic oil tank 23 is inspected, the vehicle body of the hydraulic excavator 100 and the work implement 3 are put into a predetermined hydraulic oil inspection attitude. By making the attitude of the work implement 3 constant, it is possible to suppress fluctuation of the oil level S of the hydraulic oil OL of the work implement 3 and to perform highly accurate inspection. The inspection of the hydraulic oil amount is an example of maintenance work of the hydraulic excavator 100. The hydraulic oil inspection attitude corresponds to an example of the “target attitude” of the vehicle body and the work implement 3 at the time of maintenance of the hydraulic excavator 100. The hydraulic oil inspection attitude is set in advance and stored in the memory 307.

Before the inspection of the hydraulic oil amount, the operator boarding the cab 2a can grasp whether the work implement 3 and the vehicle body are in the hydraulic oil inspection attitudes, and if they are not in the hydraulic oil inspection attitudes, the operator can easily match the work implement 3 and the vehicle body to the hydraulic oil inspection attitudes. Therefore, in the embodiment, the monitor 60 displays the work implement 3 and the vehicle body, and displays guidance for matching the work implement 3 and the vehicle body to the hydraulic oil inspection attitudes.

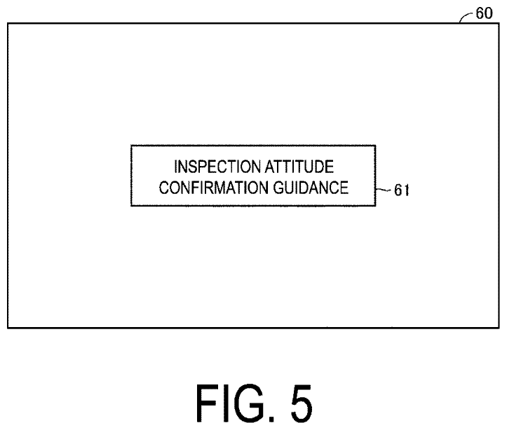

FIG. 5 is a schematic diagram illustrating an example of display on the monitor 60 when inspection of the hydraulic oil amount is started. The monitor 60 illustrated in FIG. 5 is a touch panel, and the display screen displays a message icon 61. When the operator touches the message icon 61, the processing shown in FIG. 4 is started. When the hydraulic oil amount is inspected, the hydraulic excavator 100 is not traveling but stopped.

The vehicle body of the hydraulic excavator 100 being not largely tilted from the horizon is a precondition for enabling the inspection of the hydraulic oil amount to be started. In step S11, the vehicle body attitude detection unit 301 of the controller 30 detects the attitude of the vehicle body of the hydraulic excavator 100. A detection signal indicating the tilt of the vehicle body with respect to the horizon is input to the vehicle body attitude detection unit 301 from the IMU 8a, which is the vehicle body attitude sensor. The vehicle body attitude detection unit 301 recognizes the angle of the tilt of the vehicle body of the hydraulic excavator 100 with respect to the horizon based on the input detection signal.

In step S12, the vehicle body attitude determination unit 302 of the controller 30 compares the tilt of the vehicle body detected in step S11 with a determination value. The determination value of the tilt of the vehicle body is stored in the memory 307. The determination value of the tilt of the vehicle body is, for example, an angle at which the fluctuation of the oil level S of the hydraulic oil OL in the hydraulic oil tank 23 can be suppressed sufficiently small. The determination value may be, for example, ±3°. The vehicle body attitude determination unit 302 reads the determination value from the memory 307 and determines whether the tilt of the vehicle body is equal to or less than the determination value. By determining that the tilt of the vehicle body is equal to or less than the determination value, it is confirmed that the hydraulic excavator 100 is stopped on a flat ground and is in a situation where the inspection of the hydraulic oil amount can be accurately performed.

When it is determined that the tilt of the vehicle body is larger than the determination value (NO in step S12), the output unit 306 of the controller 30 outputs guidance for reducing the tilt of the vehicle body in step S13. Specifically, the output unit 306 causes the monitor 60 to display the guidance. The output unit 306 outputs, to the monitor 60, a signal indicating the display content of the monitor 60. In response to the signal, the monitor 60 displays the current attitude of the vehicle body, the hydraulic oil inspection attitude (target attitude) of the vehicle body, and the guidance for matching the vehicle body to the hydraulic oil inspection attitude.

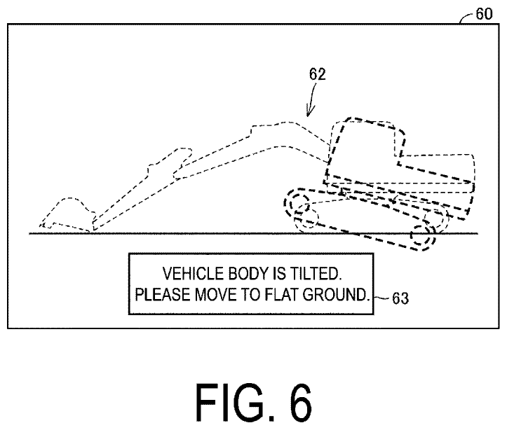

FIG. 6 is a schematic diagram illustrating an example of display on the monitor 60 when the vehicle body is tilted. In FIG. 6 and the subsequent drawings, in a work machine icon 62 displayed on the monitor 60, the hydraulic oil inspection attitudes, which are the target attitudes of the work implement 3 and the vehicle body, are indicated by thin broken lines. When the current attitudes of the work implement 3 and the vehicle body are out of the hydraulic oil inspection attitudes, the current attitudes are indicated by thick broken lines. When the current attitudes of the work implement 3 and the vehicle body match the hydraulic oil inspection attitudes, the current attitudes are indicated by thick solid lines. The outline in the current attitude of the vehicle body and the outline when it is in the target attitude are displayed on the monitor 60.

In FIG. 6, a comparison in the hydraulic excavator 100 between the current attitude and the target attitude is performed by focusing on the tilt of the vehicle body, and therefore the work machine icon 62 includes the target attitudes of the work implement 3 and the vehicle body and the current attitude of the vehicle body. In FIG. 6, the work machine icon 62 does not include the current attitude of the work implement 3, and the current attitude of the work implement 3 is not displayed on the monitor 60.

In FIG. 6, the current attitude of the vehicle body is out of the target attitude, and the current attitude of the vehicle body is indicated by a thick broken line. Specifically, the vehicle body is tilted with respect to the front-rear direction such that the front of the vehicle body is up and the rear of the vehicle body is down. As determined in step S12, the tilt of the vehicle body is larger than the determination value. Since the difference in the vehicle body between the current attitude and the target attitude is larger than the determination value, the monitor 60 displays a guidance icon 63. The guidance icon 63 includes guidance for reducing the difference in the vehicle body between the current attitude and the target attitude. Specifically, the guidance icon 63 that prompts the operator to perform an operation of moving the hydraulic excavator 100 to a flat ground is displayed.

The processing returns to step S11, and the processing of detecting the attitude of the vehicle body of the hydraulic excavator 100 is repeated.

As a result of the vehicle body being moved to the flat ground by the operator in accordance with the content of the guidance icon 63 illustrated in FIG. 6, when it is determined that the tilt of the vehicle body is equal to or less than the determination value in the determination of step S12 (YES in step S12), the processing proceeds to step S14.

In step S14, the work implement attitude detection unit 303 of the controller 30 detects the attitude of the arm 3b of the work implement 3 and the attitude of the bucket 3c. For example, a detection signal indicating a displacement amount of a rod with respect to a cylinder tube in the arm cylinder 4b is input to the work implement attitude detection unit 303 from the stroke sensor 7b included in the work implement attitude sensors. A detection signal indicating a displacement amount of the rod with respect to the cylinder tube in the bucket cylinder 4c is input to the work implement attitude detection unit 303 from the stroke sensor 7c.

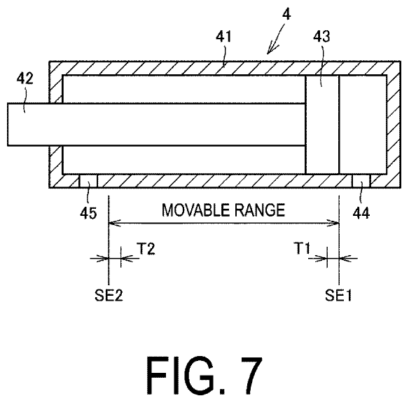

FIG. 7 is a partial cross-sectional view illustrating a schematic configuration of a hydraulic cylinder 4. The configuration of the hydraulic cylinder 4 illustrated in FIG. 7 is applied to the arm cylinder 4b and the bucket cylinder 4c of the hydraulic excavator 100. The hydraulic cylinder 4 includes a cylinder tube 41, a rod 42, and a piston 43.

The piston 43 is accommodated in a cylinder chamber inside the cylinder tube 41. The piston 43 can reciprocate in the cylinder chamber in a longitudinal direction (axial direction, the left-right direction in the drawing in FIG. 7) of the cylinder tube 41. The rod 42 extends in the longitudinal direction of the cylinder tube 41. A base end of the rod 42 is disposed in the cylinder chamber of the cylinder tube 41 and is fixed to the piston 43. A tip of the rod 42 protrudes to the outside of the cylinder tube 41.

The cylinder chamber inside the cylinder tube 41 is partitioned into an oil chamber on the cylinder head side and an oil chamber on the cylinder bottom side by the piston 43. A bottom side port 44 is formed in the oil chamber on the cylinder bottom side. A hydraulic pipe is connected to the bottom side port 44. A head side port 45 is formed in the oil chamber on the cylinder head side. A hydraulic pipe is connected to the head side port 45.

Supply of the hydraulic oil to the oil chamber on the cylinder bottom side and emission of the hydraulic oil from the oil chamber on the cylinder bottom side are performed through the bottom side port 44. Supply of the hydraulic oil to the oil chamber on the cylinder head side and emission of the hydraulic oil from the oil chamber on the cylinder head side are performed through the head side port 45. When the hydraulic oil is supplied to the oil chamber on the cylinder bottom side, the hydraulic cylinder 4 extends, and the hydraulic oil on the cylinder head side is returned to the hydraulic oil tank 23. When the hydraulic oil is supplied to the oil chamber on the cylinder head side, the hydraulic cylinder 4 contracts, and the hydraulic oil on the cylinder bottom side is returned to the hydraulic oil tank 23.

The piston 43 can reciprocate in a movable range between a stroke end SE1 on a contraction side and a stroke end SE2 on an extension side illustrated in FIG. 7. The stroke sensor 7b of the arm cylinder 4b detects the current position of the piston 43 of the arm cylinder 4b, and inputs the detected result to the work implement attitude detection unit 303. The stroke sensor 7c of the bucket cylinder 4c detects the current position of the piston 43 of the bucket cylinder 4c, and inputs the detected result to the work implement attitude detection unit 303. The work implement attitude detection unit 303 recognizes the current attitude of the arm 3b and the current attitude of the bucket 3c based on the input detection signal.

In step S15, the work implement attitude determination unit 304 of the controller 30 compares the current attitudes detected in step S14 with the target attitudes of the arm 3b and the bucket 3c. The arm 3b in the target attitude (hydraulic oil inspection attitude) is disposed at a position closest to a dump side with respect to the boom 3a. The bucket 3c in the target attitude (hydraulic oil inspection attitude) is disposed at a position closest to the dump side with respect to the arm 3b.

As illustrated in FIG. 7, in the hydraulic cylinder 4, a tolerance T1 is set for the stroke end SE1 on the contraction side. A tolerance T2 is set for the stroke end SE2 on the extension side. The tolerances T1 and T2 of the cylinder length are, for example, lengths with which fluctuation of the oil level S of the hydraulic oil OL in the hydraulic oil tank 23 can be sufficiently suppressed. The tolerances T1 and T2 may be, for example, 20 mm. The tolerances T 1 and T2 are stored in the memory 307.

The work implement attitude determination unit 304 compares an end surface of the piston 43 of the arm cylinder 4b (the surface on the right side of the piston 43 in FIG. 7) with the stroke end SE1 on the contraction side of the piston 43. The work implement attitude determination unit 304 compares an end surface of the piston 43 of the bucket cylinder 4c (the surface on the right side of the piston 43 in FIG. 7) with the stroke end SE1 on the contraction side of the piston 43.

In step S16, the work implement attitude determination unit 304 compares the difference in the arm 3b and the bucket 3c between the current attitudes and the target attitudes with the determination value.

The work implement attitude determination unit 304 reads the tolerance T1 from the memory 307, and determines whether the end surface of the piston 43 of the arm cylinder 4b is within a range of the tolerance T1 from the stroke end SE1 on the contraction side. The determination value of the attitude of the arm 3b is the tolerance T1 of the arm cylinder 4b.

The work implement attitude determination unit 304 reads the tolerance T1 from the memory 307, and determines whether the end surface of the piston 43 of the bucket cylinder 4c is within a range of the tolerance T1 from the stroke end SE1 on the contraction side. The determination value of the attitude of the bucket 3c is the tolerance T1 of the bucket cylinder 4c.

By determining that the pistons 43 of the arm cylinder 4b and the bucket cylinder 4c are within the range of the tolerance T1 from the stroke end SE1 on the contraction side, it is confirmed to be in a situation where the amounts of the hydraulic oil OL in the arm cylinder 4b and the bucket cylinder 4c are small, and a larger amount of the hydraulic oil OL is stored in the hydraulic oil tank 23.

When it is determined that the difference in the arm 3b and the bucket 3c between the current attitudes and the target attitudes is larger than the determination value (NO in step S16), the output unit 306 of the controller 30 outputs in step S17 the current attitudes and the hydraulic oil inspection attitudes (target attitudes) of the arm 3b and the bucket 3c, and guidance for reducing the difference between the current attitudes and the target attitudes. Specifically, the output unit 306 outputs, to the monitor 60, a signal indicating the display content of the monitor 60. In response to the signal, the monitor 60 displays the current attitudes and the hydraulic oil inspection attitudes (target attitudes) of the arm 3b and the bucket 3c, and guidance for reducing the difference between the current attitudes and the target attitudes.

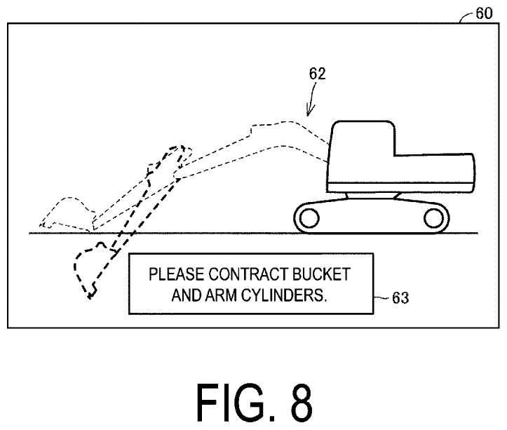

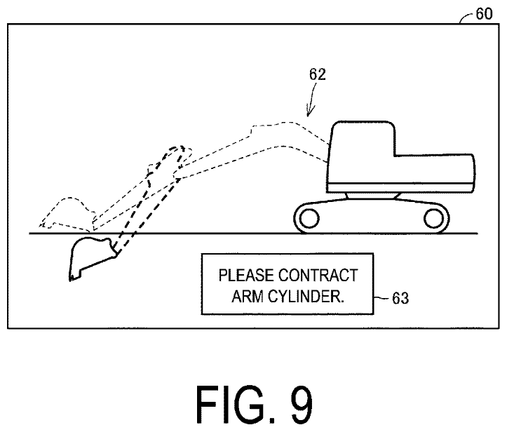

FIG. 8 is a schematic diagram illustrating an example of display on the monitor 60 when the arm 3b and the bucket 3c are out of the target attitudes. In FIG. 8 and subsequent FIGS. 9 to 11, a comparison in the hydraulic excavator 100 between the current attitude and the target attitude is performed by focusing on the attitudes of the arm 3b and the bucket 3c of the work implement 3, and therefore the work machine icon 62 includes the current attitudes of the arm 3b and the bucket 3c. In FIGS. 8 to 11, the work machine icon 62 does not include the current attitude of the boom 3a, and the current attitude of the boom 3a is not displayed on the monitor 60.

The outlines in the current attitudes of the work implement 3 and the vehicle body and the outlines when they are in the target attitudes are displayed on the monitor 60. Since the operation of reducing the tilt of the vehicle body has already been performed, the current attitude of the vehicle body matches the target attitude, and the current attitude of the vehicle body is indicated by a thick solid line in FIG. 8. The current attitudes of the arm 3b and the bucket 3c are out of the target attitudes, and the current attitudes of the arm 3b and the bucket 3c are indicated by thick broken lines.

Specifically, the end surface of the piston 43 of the arm cylinder 4b is separated from the stroke end SE1 on the contraction side by more than the tolerance T1. The end surface of the piston 43 of the bucket cylinder 4c is separated from the stroke end SE1 on the contraction side by more than the tolerance T1.

Since the difference in the arm 3b and the bucket 3c between the current attitudes and the target attitudes is larger than the determination value, the guidance icon 63 is displayed on the monitor 60. The guidance icon 63 includes guidance for reducing the difference in the arm 3b and the bucket 3c between the current attitudes and the target attitudes. Specifically, the guidance icon 63 that prompts the operator to perform an operation of contracting the bucket cylinder 4c and the arm cylinder 4b is displayed.

FIG. 9 is a schematic diagram illustrating an example of display on the monitor 60 when the arm 3b is out of the target attitude. Also in FIG. 9, the current attitude of the vehicle body matches the target attitude, and the current attitude of the vehicle body is indicated by a thick solid line. The current attitude of the bucket 3c matches the target attitude, and the current attitude of the bucket 3c is indicated by a thick solid line. The current attitude of the arm 3b is out of the target attitude, and the current attitude of the arm 3b is indicated by a thick broken line. Specifically, the end surface of the piston 43 of the arm cylinder 4b is separated from the stroke end SE1 on the contraction side by more than the tolerance T1.

Since the difference in the arm 3b between the current attitude and the target attitude is larger than the determination value, the guidance icon 63 is displayed on the monitor 60. The guidance icon 63 includes guidance for reducing the difference in the arm 3b between the current attitude and the target attitude. Specifically, the guidance icon 63 that prompts the operator to perform an operation of contracting the arm cylinder 4b is displayed.

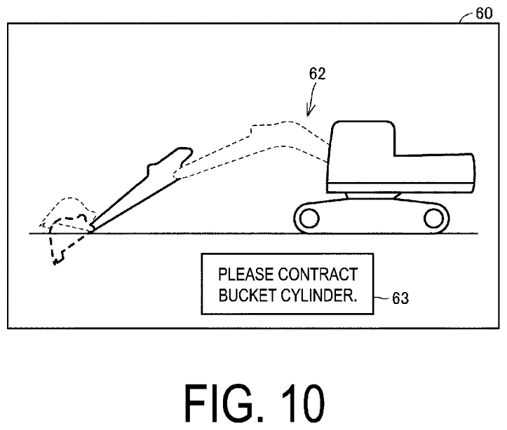

FIG. 10 is a schematic diagram illustrating an example of display on the monitor 60 when the bucket 3c is out of the target attitude. Also in FIG. 10, the current attitude of the vehicle body matches the target attitude, and the current attitude of the vehicle body is indicated by a thick solid line. The current attitude of the arm 3b matches the target attitude, and the current attitude of the arm 3b is indicated by a thick solid line. The current attitude of the bucket 3c is out of the target attitude, and the current attitude of the bucket 3c is indicated by a thick broken line. Specifically, the end surface of the piston 43 of the bucket cylinder 4c is separated from the stroke end SE1 on the contraction side by more than the tolerance T1.

Since the difference in the bucket 3c between the current attitude and the target attitude is larger than the determination value, the guidance icon 63 is displayed on the monitor 60. The guidance icon 63 includes guidance for reducing the difference in the bucket 3c between the current attitude and the target attitude. Specifically, the guidance icon 63 that prompts the operator to perform an operation of contracting the bucket cylinder 4c is displayed.

The processing returns to step S14, and the processing of detecting the attitude of the arm 3b of the work implement 3 and the attitude of the bucket 3c is repeated.

As a result of the arm cylinder 4b being contracted by the operator in accordance with the content of the guidance icon 63 illustrated in FIGS. 8 to 10 to move the arm 3b in a dump direction and the bucket cylinder 4c being contracted to move the bucket 3c in the dump direction, when it is determined that the difference in the arm 3b and the bucket 3c between the current attitudes and the target attitudes is equal to or less than the determination value in the determination of step S16 (YES in step S16), the processing proceeds to step S18.

In step S18, the output unit 306 outputs the current attitudes and the hydraulic oil inspection attitudes (target attitudes) of the arm 3b and the bucket 3c. Specifically, the output unit 306 outputs, to the monitor 60, a signal indicating the display content of the monitor 60. In response to the signal, the monitor 60 displays the current attitudes and the hydraulic oil inspection attitudes (target attitudes) of the arm 3b and the bucket 3c.

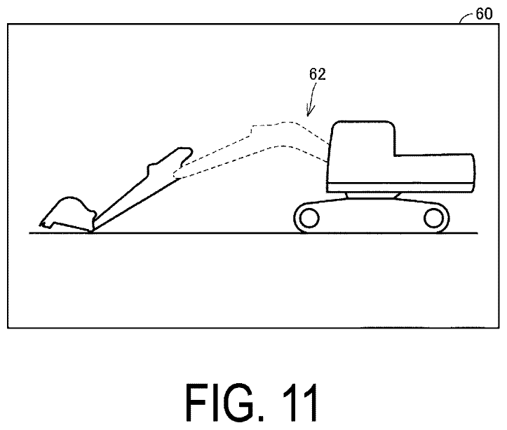

FIG. 11 is a schematic diagram illustrating an example of display on the monitor 60 when the arm 3b and the bucket 3c match the target attitudes. As a result of the work implement 3 operated by the operator of the hydraulic excavator 100 in accordance with the guidance illustrated in FIGS. 8 to 10, the attitudes of the vehicle body, the arm 3b, and the bucket 3c all match the target attitudes and are indicated by thick solid lines in FIG. 11. In FIG. 11, the guidance icon 63 is not displayed.

Next, in step S19, the work implement attitude determination unit 304 detects the position of the distal end portion of the arm 3b with respect to the ground on which the vehicle body is placed.

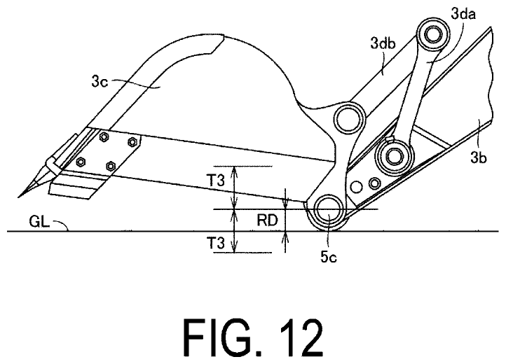

FIG. 12 is an enlarged side view illustrating a vicinity of the distal end portion of the arm 3b. As described with reference to FIG. 1, the arm top pin 5c couples the arm 3b and the bucket 3c. The vehicle body of the hydraulic excavator 100 is placed on a ground GL illustrated in FIG. 12. A ground contact surface of the crawler track of the crawler track device la (FIG. 1) is in contact with the ground GL.

The bucket 3c rotates relative to the arm 3b, and the center of the arm top pin 5c is the center of the relative rotation. The work implement attitude detection unit 303 acquires the position of the center of the arm top pin 5c in the up-down direction.

For example, a detection signal indicating a displacement amount of a rod with respect to a cylinder tube in the boom cylinder 4a is input to the work implement attitude detection unit 303 from the stroke sensor 7a included in the work implement attitude sensors. A detection signal indicating a displacement amount of the rod with respect to the cylinder tube in the arm cylinder 4b is input to the work implement attitude detection unit 303 from the stroke sensor 7b. The work implement attitude detection unit 303 recognizes the current attitude of the boom 3a and the current attitude of the arm 3b based on the input detection signal.

By the ground GL on which the vehicle body is placed, the current attitude of the boom 3a with respect to the vehicle body, and the current attitude of the arm 3b with respect to the boom 3a, the work implement attitude detection unit 303 detects at what position the center of the arm top pin 5c is present with respect to the ground GL in the up-down direction. Note that at this time, the end surface of the piston 43 of the arm cylinder 4b is in the range of the tolerance T1 or less from the stroke end SE1 on the contraction side, and the arm 3b is disposed at the position closest to the dump side with respect to the boom 3a.

In step S20, the work implement attitude determination unit 304 compares the current attitude with the target attitude of the boom 3a detected in step S19.

As illustrated in FIG. 12, a reference distance RD with respect to the ground GL and a tolerance T3 with respect to the reference distance RD are set at the center of the arm top pin 5c in side view. The reference distance RD is a predetermined value determined for each vehicle size class of the hydraulic excavator 100. The tolerance T3 with respect to the reference distance RD is, for example, a length with which fluctuation of the oil level S of the hydraulic oil OL in the hydraulic oil tank 23 can be sufficiently suppressed. The tolerance T3 may be 200 mm, for example. The reference distance RD and the tolerance T3 are stored in the memory 307.

The tolerance T3 may be larger than the reference distance RD. The center of the arm top pin 5c may be disposed upward away from the ground GL, and may be disposed below the ground GL.

The work implement attitude determination unit 304 compares the position of the center of the arm top pin 5c in the up-down direction with the reference distance RD.

In step S21, the work implement attitude determination unit 304 compares the difference in the boom 3a between the current attitude and the target attitude with the determination value. The work implement attitude determination unit 304 reads the tolerance T3 from the memory 307, and determines whether the center of the arm top pin 5c is within a range of the tolerance T3 from the reference distance RD. The determination value of the boom 3a is the tolerance T3 of the center of the arm top pin 5c.

When it is determined that the difference in the boom 3a between the current attitude and the target attitude is larger than the determination value (NO in step S21), the output unit 306 of the controller 30 outputs in step S22 the current attitude and the hydraulic oil inspection attitude (target attitude) of the boom 3a, and guidance for reducing the difference between the current attitude and the target attitude. Specifically, the output unit 306 outputs, to the monitor 60, a signal indicating the display content of the monitor 60. In response to the signal, the monitor 60 displays the current attitude and the hydraulic oil inspection attitude (target attitude) of the boom 3a, and guidance for reducing the difference between the current attitude and the target attitude.

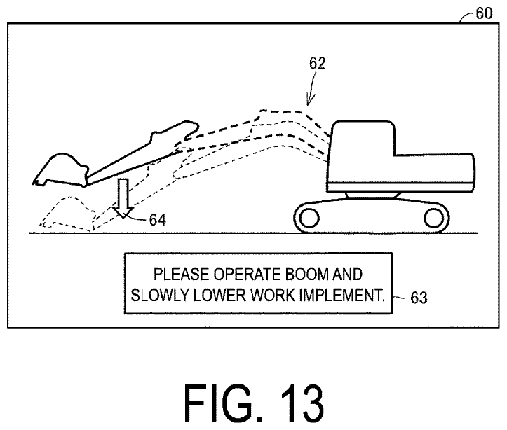

FIG. 13 is a schematic diagram illustrating an example of display on the monitor 60 when the boom 3a is above the target position. In FIG. 13, the current attitudes of the vehicle body, the arm 3b, and the bucket 3c all match the target attitudes, and the current attitudes of the vehicle body, the arm 3b, and the bucket 3c are indicated by thick solid lines. The current attitude of the boom 3a is out of the target attitude, and the current attitude of the boom 3a is indicated by a thick broken line. The boom 3a is disposed above the target attitude. The center of the arm top pin 5c is separated upward from the reference distance RD by more than the tolerance T3.

Since the difference in the boom 3a between the current attitude and the target attitude is larger than the determination value, the guidance icon 63 is displayed on the monitor 60. The guidance icon 63 includes guidance for reducing the difference in the boom 3a between the current attitude and the target attitude. Specifically, the guidance icon 63 that prompts the operator to perform an operation of lowering the boom 3a is displayed. An arrow icon 64 whose arrow indicates a direction in which the boom 3a should be moved is also displayed on the monitor 60. The arrow icon 64 of a downward arrow is displayed on the monitor 60 illustrated in FIG. 13.

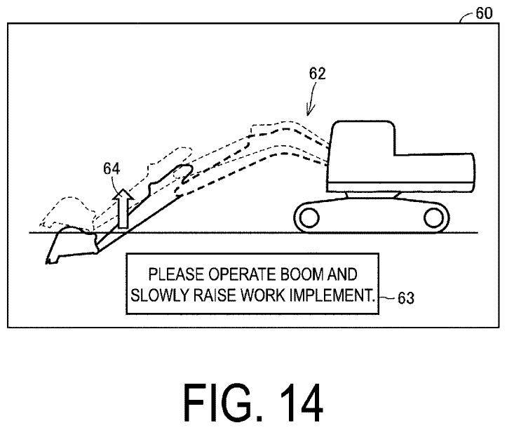

FIG. 14 is a schematic diagram illustrating an example of display on the monitor 60 when the boom 3a is below the target position. In FIG. 14, the current attitudes of the vehicle body, the arm 3b, and the bucket 3c all match the target attitudes, and the current attitudes of the vehicle body, the arm 3b, and the bucket 3c are indicated by thick solid lines. The current attitude of the boom 3a is out of the target attitude, and the current attitude of the boom 3a is indicated by a thick broken line. The boom 3a is disposed lower than the target attitude. The center of the arm top pin 5c is separated downward from the reference distance RD by more than the tolerance T3.

Since the difference in the boom 3a between the current attitude and the target attitude is larger than the determination value, the guidance icon 63 is displayed on the monitor 60. The guidance icon 63 includes guidance for reducing the difference in the boom 3a between the current attitude and the target attitude. Specifically, the guidance icon 63 that prompts the operator to perform an operation of raising the boom 3a is displayed. The arrow icon 64 whose arrow indicates the direction in which the boom 3a should be moved is also displayed on the monitor 60. The arrow icon 64 of an upward arrow is displayed on the monitor 60 illustrated in FIG. 14.

The processing returns to step S19, and the processing of detecting the position of the distal end portion of the arm 3b of the work implement 3 is repeated.

As a result of the boom 3a being moved by the operator in accordance with the content of the guidance icon 63 and the arrow icon 64 illustrated in FIGS. 13 and 14, when the center of the arm top pin 5c is disposed in the range of the tolerance T3 from the reference distance RD, it is determined that the difference in the boom 3a between the current attitude and the target attitude is equal to or less than the determination value in the determination in step S21 (YES in step S21), and the processing proceeds to step S23.

In step S23, the hydraulic oil amount determination unit 305 of the controller 30 executes confirmation as to whether the current storage amount of the hydraulic oil OL in the hydraulic oil tank 23 is appropriate. The oil amount sensor 28 (FIG. 2) attached to the hydraulic oil tank 23 detects the current height of the oil level S of the hydraulic oil OL in the hydraulic oil tank 23, and inputs the detected result to the hydraulic oil amount determination unit 305. The hydraulic oil amount determination unit 305 performs confirmation of the hydraulic oil amount based on the input detection signal.

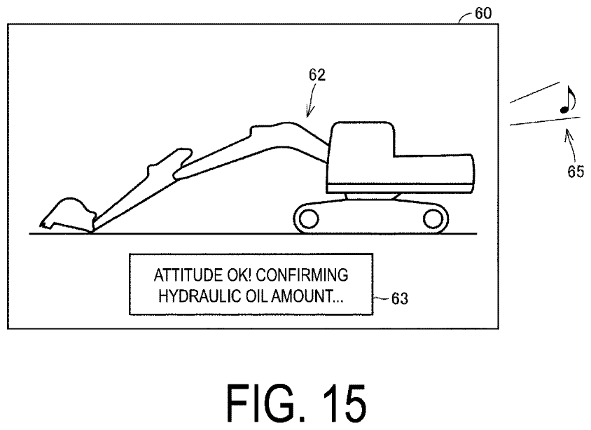

FIG. 15 is a schematic diagram illustrating an example of display on the monitor 60 when the vehicle body and the work implement 3 match the target attitudes. Since both the vehicle body and the work implement 3 match the target attitudes, both the vehicle body and the work implement 3 are indicated by thick solid lines. The fact that both the vehicle body and the work implement 3 match the target attitudes is notified also by voice notification 65, and the operator can recognize that the attitudes match without gazing at the monitor 60. The guidance icon 63 displays a message indicating that confirmation of the hydraulic oil amount is in execution.

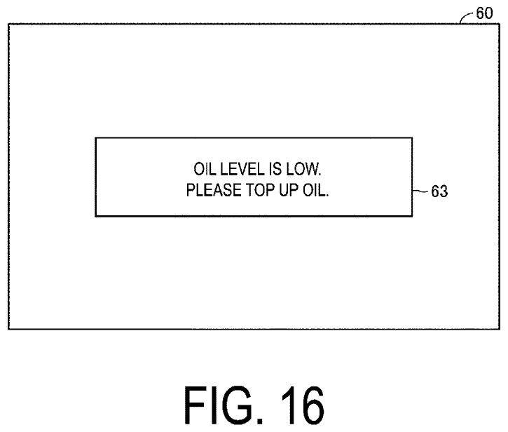

In step S24, the output unit 306 outputs the result of the hydraulic oil amount confirmation. When an appropriate amount of the hydraulic oil OL is stored in the hydraulic oil tank 23, no special message is output, and the monitor 60 displays a screen indicating a state where the work can be started. On the other hand, when it is determined that the storage amount of the hydraulic oil OL in the hydraulic oil tank 23 is small, the state does not transition to a state where the work can be started. FIG. 16 is a schematic diagram illustrating an example of display on the monitor 60 when the storage amount of the hydraulic oil in the hydraulic oil tank 23 is small. As illustrated in FIG. 16, when it is determined that the storage amount of the hydraulic oil in the hydraulic oil tank 23 is small, the monitor 60 displays the message icon 61 prompting top-up of the hydraulic oil OL.

In this manner, a series of processing of automatically inspecting the storage amount of the hydraulic oil OL in the hydraulic oil tank 23 at the time of pre-operation inspection is ended (“end” in FIG. 4).

According to the flow of the processing shown in FIG. 4, it is confirmed whether the work implement 3 and the vehicle body are in the hydraulic oil inspection attitudes, which are the target attitudes, before the inspection of the hydraulic oil amount. By confirming the display content of the monitor 60, the operator of the hydraulic excavator 100 can easily match the work implement 3 and the vehicle body to the hydraulic oil inspection attitudes. When the work implement 3 and the vehicle body are in the hydraulic oil inspection attitudes, the hydraulic oil amount in the hydraulic oil tank 23 is automatically confirmed. Since it is not necessary for the operator to get out of the cab and visually inspect the oil amount, it is possible to efficiently perform inspection of a hydraulic oil amount.

### Attitude Detection When Work Machine is Stopped

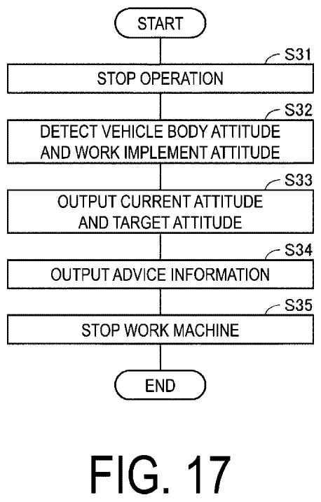

The comparison in the vehicle body and the work implement 3 between the current attitudes and the target attitudes may be executed not only at the time of the pre-operation inspection described above but also at the time of a stop operation of the hydraulic excavator 100. FIG. 17 is a flowchart showing a flow of operation when the work machine is stopped.

As shown in FIG. 17, in step S31, the operator of the hydraulic excavator 100 performs an operation of stopping the hydraulic excavator 100. Specifically, the operator performs an off operation of an engine key.

When the off operation of the engine key is performed, in step S32, the vehicle body attitude detection unit 301 of the controller 30 detects the current attitude of the vehicle body of the hydraulic excavator 100, and the work implement attitude detection unit 303 of the controller 30 detects the current attitude of the work implement 3. The detection of the attitude of the vehicle body can be performed based on the detection result of the IMU 8a, similarly to step S11 shown in FIG. 4. The detection of the attitude of the work implement 3 can be performed based on the detection results of the stroke sensors 7a, 7b, and 7c as described in steps S14 and S19.

In step S33, the output unit 306 of the controller 30 outputs the current attitudes and the hydraulic oil inspection attitudes (target attitudes) of the vehicle body and the work implement 3. The output of the attitude can be performed by displaying the work machine icon 62 on the monitor 60, similarly to the processing shown in FIG. 4.

In step S34, the output unit 306 outputs advice information regarding the target attitudes of the vehicle body and the work implement 3. The output unit 306 may output the advice information by display on the monitor 60 or may output it as voice guidance. The advice information may be, for example, a recommendation of putting the vehicle body and the work implement 3 into the target attitudes at the time of stopping of the hydraulic excavator 100. Since the target attitude is the hydraulic oil inspection attitude at the time of pre-operation inspection, if the vehicle body and the work implement 3 are put into the target attitudes at the time of stopping of the hydraulic excavator 100, it is not necessary to perform processing of matching the vehicle body and the work implement 3 to the target attitudes at the time of the next pre-operation inspection. This can shorten the time required for the pre-operation inspection, and enables the work to be promptly started.

In step S35, the engine 21 is stopped, and the operation of the hydraulic excavator 100 is stopped. In this manner, a series of processing of stopping the hydraulic excavator 100 is ended (“end” in FIG. 17).

### Actions and Effects

Although some parts overlap with the description provided above, the characteristic configurations and the actions and effects of the present embodiment are summarized as follows.

As illustrated in FIGS. 1 and 2, the IMU 8a detects the current attitude of the vehicle body of the hydraulic excavator 100. The stroke sensors 7a, 7b, and 7c detect the current attitude of the work implement 3. As illustrated in FIGS. 4 and 6 to 15, the controller 30 executes a comparison in the vehicle body and the work implement 3 between the current attitude and the target attitude at the time of maintenance set in advance, and outputs a result of the comparison.

From the result of the comparison in the attitude between the vehicle body and the work implement 3, the operator of the hydraulic excavator 100 can recognize whether the current attitude of the hydraulic excavator 100 is the target attitude, how the vehicle body and the work implement 3 are currently disposed with respect to the target attitude, and how to move the vehicle body and the work implement 3 to achieve the target attitudes. The hydraulic oil inspection attitude at the time of pre-operation inspection can be put into the target attitude, and the vehicle body and the work implement 3 can be easily put into the hydraulic oil inspection attitudes based on the result of the comparison between the current attitudes and the target attitudes. After the vehicle body and the work implement 3 are put into the hydraulic oil inspection attitudes, inspection of the hydraulic oil amount in the hydraulic oil tank 23 can be promptly performed. Therefore, it is possible to efficiently perform inspection of a hydraulic oil amount.

As illustrated in FIGS. 6 to 15, the controller 30 may display, on the monitor 60, the result of the comparison in the vehicle body and the work implement 3 between the current attitudes and the target attitudes. From the display content of the monitor 60, the operator of the hydraulic excavator 100 can easily recognize how to operate the hydraulic excavator 100 to bring the vehicle body and the work implement 3 close to the target attitudes.

As illustrated in FIGS. 6 to 15, the controller 30 may display, on the monitor 60, the outline in the current attitudes of the vehicle body and the work implement 3 and the outline when they are in the target attitudes. The operator of the hydraulic excavator 100 can easily and clearly recognize the difference in the vehicle body and the work implement 3 between the current attitudes and the target attitudes by viewing the work machine icon 62 displayed on the monitor 60.

As illustrated in FIG. 6 to 14, when the difference in the vehicle body and the work implement 3 between the current attitudes and the target attitudes is larger than the determination value, the controller 30 may output guidance for reducing the difference. By operating the hydraulic excavator 100 in accordance with the guidance, the operator of the hydraulic excavator 100 can bring the attitudes of the vehicle body and the work implement 3 close to the target attitudes, and can reduce the difference between the current attitudes and the target attitudes.

As shown in FIG. 17, the current attitudes of the vehicle body and the work implement 3 may be detected at the time of the stop operation of the hydraulic excavator 100. The controller 30 executes a comparison in the vehicle body and the work implement 3 between the current attitudes and the target attitudes at the time of the stop operation of the hydraulic excavator 100, and outputs a result of the comparison. Based on the result of the comparison in the attitude, the operator of the hydraulic excavator 100 can perform an operation so as to bring the vehicle body and the work implement 3 close to the target attitudes at the time of the next stopping of the hydraulic excavator 100.

As shown in FIG. 17, the controller 30 may output advice information regarding the target attitudes of the vehicle body and the work implement 3 at the time of the stop operation of the hydraulic excavator 100. In accordance with the advice information, the operator of the hydraulic excavator 100 can perform an operation so as to bring the vehicle body and the work implement 3 close to the target attitudes at the time of the next stopping of the hydraulic excavator 100.

As illustrated in FIG. 12, the position of the distal end portion of the arm 3b with respect to the ground GL on which the vehicle body of the hydraulic excavator 100 is placed may be detected from the detection results of the stroke sensors 7a and 7b. The attitude in which the distal end portion of the arm 3b is in contact with the ground GL can be the target attitude, and by determining the attitude in this manner, variation in the hydraulic oil amount in the hydraulic oil tank 23 when it is in the target attitude is reduced, and therefore the hydraulic oil amount can be accurately inspected.

As illustrated in FIG. 7, the stroke sensor 7b of the arm cylinder 4b may detect whether the arm cylinder 4b is at the stroke end SE1 on the contraction side, and the stroke sensor 7c of the bucket cylinder 4c may detect whether the bucket cylinder 4c is at the stroke end SE1 on the contraction side. By making the attitude when the arm cylinder 4b and the bucket cylinder 4c are at the stroke end SE1 as the target attitude of the work implement 3, the variation in the hydraulic oil amount in the hydraulic oil tank 23 when it is in the target attitude is reduced, and therefore the hydraulic oil amount can be accurately inspected.

As illustrated in FIGS. 1 and 2, the IMU 8a attached to the vehicle body of the hydraulic excavator 100 may detect the tilt of the vehicle body. The hydraulic oil tank 23 is equipped on the vehicle body, and when the hydraulic oil tank 23 is tilted, the accuracy of inspection of the hydraulic oil amount decreases. From the result of the comparison between the current tilt of the vehicle body detected by the IMU 8a and the target attitude related to the tilt of the vehicle body, it is possible to recognize that the tilt of the vehicle body is at a degree not affecting the accuracy of inspection of the hydraulic oil amount, and therefore it is possible to accurately inspect the hydraulic oil amount.

As illustrated in FIG. 6, the controller 30 may output the tilt of the vehicle body with respect to the horizon. The controller 30 outputs a result of comparing the current tilt of the vehicle body with respect to the horizon with the target attitude related to the tilt of the vehicle body. The operator of the hydraulic excavator 100 can easily grasp whether the hydraulic excavator 100 is stopped on a flat ground where the hydraulic oil amount can be accurately inspected. When the tilt of the vehicle body is large, it is possible to promptly start inspection of the hydraulic oil amount by quickly moving to the flat ground.

As illustrated in FIGS. 2, 4, 15, and 16, when the difference in the vehicle body and the work implement 3 between the current attitudes and the target attitudes is smaller than the determination value, the controller 30 may execute confirmation as to whether the current storage amount of the hydraulic oil OL in the hydraulic oil tank 23 detected by the oil amount sensor 28 is appropriate, and output a result of the confirmation. When the current attitudes of the vehicle body and the work implement 3 match the target attitudes, the inspection of the hydraulic oil amount is automatically executed. It is possible to perform inspection of the hydraulic oil amount in the hydraulic oil tank 23 without the operator getting out of the cab 2a, and it is possible to efficiently perform inspection of a hydraulic oil amount.

In the above embodiment, an example in which the attitude of the work implement 3 is obtained from the detection results of the stroke sensors 7a, 7b, and 7c has been described. The current attitude of the work implement 3 may be obtained using other types of work implement attitude sensors the IMUs 8b, 8c, and 8d or the angle sensors 9a, 9b, and 9c illustrated in FIG. 1, for example. A plurality of types of work implement attitude sensors may be used.

In the above embodiment, an example in which the result of comparing the current attitudes with the target attitudes of the vehicle body and the work implement 3 is displayed on the monitor 60 has been described. If the monitor 60 can perform color display, of the current attitudes of the vehicle body and the work implement 3, those matching the target attitudes, and those out of the target attitudes, may be displayed in different colors. The difference in the vehicle body and the work implement 3 between the current attitudes and the target attitudes may be displayed by animation.

The output unit 306 of the controller 30 may output the result of the comparison by voice in place of or in addition to the display on the monitor 60. The output unit 306 may output, using arbitrary means, arbitrary information such as the result of the comparison in the attitude between the vehicle body and the work implement 3, the oil amount in the hydraulic oil tank 23, and the advice information described with reference to FIG. 17.

In the above embodiment, an example in which the lengths of the arm cylinder 4b and the bucket cylinder 4c are minimized when they are in the hydraulic oil inspection attitudes has been described. The work implement inspection attitude may be another attitude. For example, the attitude in which the lengths of the boom cylinder 4a, the arm cylinder 4b, and the bucket cylinder 4c are maximized, the boom 3a is disposed highest with respect to the vehicle body, the arm 3b is disposed at the position on the most excavation side with respect to the boom 3a, and the bucket 3c is disposed at the position on the most excavation side with respect to the arm 3b may be the work implement inspection attitude. Alternatively, an attitude in which the arm 3b extends substantially perpendicular to the ground GL may be the work implement inspection attitude.

The controller that executes the comparison in the vehicle body and the work implement 3 of the hydraulic excavator 100 between the current attitudes and the target attitudes described in the above embodiment need not necessarily be equipped on the hydraulic excavator 100. The controller equipped on the hydraulic excavator 100 may perform processing of transmitting, to an external controller, information acquired by the IMU 8a, the stroke sensors 7a, 7b, and 7c, and the like, and the external controller having received a signal may execute comparison between the current attitudes and the target attitudes and output a result of the comparison.

The external controller may be a portable device. The external controller may be a mobile device that can be carried and used by a worker, such as a laptop personal computer, a tablet computer, or a smartphone. The external controller may be disposed at the work site of the hydraulic excavator 100 or may be disposed at a remote place away from the work site of the hydraulic excavator 100.

In the embodiment, an example in which the hydraulic excavator 100 includes the cab 2a and is a manned vehicle in which the operator boards the cab 2a has been described. The hydraulic excavator 100 may be an unmanned vehicle. The hydraulic excavator 100 need not include the cab 2a for the operator to board and operate. The hydraulic excavator 100 need not be equipped with a manipulation function by a boarding operator. The hydraulic excavator 100 may be a work machine dedicated to remote manipulation. Manipulation of the hydraulic excavator 100 may be performed by a wireless signal from a remote manipulation device. The attitudes of the vehicle body and the work implement 3 may be displayed on a monitor provided in the remote manipulation device.

In the embodiment, the hydraulic excavator 100 has been described as an example of the work machine, but the idea of the present disclosure may be applied not only to the hydraulic excavator 100 but also to other types of work machines such as a wheel loader.

### Supplementary Notes

The above description includes the following additional features.

### Supplementary Note 1

A work machine including:
a vehicle body;
a work implement supported by the vehicle body;
a detection device that detects at least any one of an attitude of the vehicle body and an attitude of the work implement; and
a controller that executes a comparison in at least any one of the vehicle body and the work implement between a current attitude detected by the detection device and a target attitude at a time of maintenance set in advance, and outputs a result of the comparison.

### Supplementary Note 2

The work machine according to supplementary note 1 further including a monitor that displays information, in which
the controller displays, on the monitor, a result of the comparison between the current attitude and the target attitude.

### Supplementary Note 3

The work machine according to supplementary note 2, in which the controller displays, on the monitor, an outline in the current attitude and an outline when assuming the target attitude of at least any one of the vehicle body and the work implement.

### Supplementary Note 4

The work machine according to any one of supplementary notes 1 to 3, in which the controller outputs guidance for reducing a difference when the difference between the current attitude and the target attitude is larger than a determination value.

### Supplementary Note 5

The work machine according to any one of supplementary notes 1 to 4, in which the detection device detects the current attitude at a time of a stop operation of the work machine.

### Supplementary Note 6

The work machine according to any one of supplementary notes 1 to 5, in which the controller outputs advice information regarding the target attitude of at least any one of the vehicle body and the work implement at the time of the stop operation of the work machine.

### Supplementary Note 7

The work machine according to any one of supplementary notes 1 to 6, in which
the work implement includes a boom coupled to the vehicle body, an arm coupled to the boom, and a bucket coupled to the arm, and
the detection device detects a position of a distal end portion of the arm with respect to a ground on which the vehicle body is placed.

### Supplementary Note 8

The work machine according to supplementary note 7, in which the work machine further includes an arm cylinder that operates the arm and a bucket cylinder that operates the bucket, and
the detection device detects whether the arm cylinder is at a stroke end, and detects whether the bucket cylinder is at a stroke end.

### Supplementary Note 9

The work machine according to any one of supplementary notes 1 to 8, in which the detection device includes a tilt sensor that is attached to the vehicle body and detects a tilt of the vehicle body.

### Supplementary Note 10

The work machine according to supplementary note 9, in which the controller outputs the tilt of the vehicle body with respect to a horizon.

### Supplementary Note 11

The work machine according to any one of supplementary notes 1 to 10 further including:
a hydraulic oil tank that stores hydraulic oil to be supplied to the work implement; and
an oil amount sensor that detects a storage amount of the hydraulic oil in the hydraulic oil tank, in which
when a difference between the current attitude and the target attitude is smaller than a determination value, the controller executes confirmation as to whether the storage amount, of the hydraulic oil, that is current and detected by the oil amount sensor is appropriate, and outputs a result of the confirmation.

It should be understood that the embodiment disclosed herein is illustrative in all respects and is not restrictive. The scope of the present invention is not limited to the description given above, and is defined by the claims and intended to include all modifications within the meaning and scope equivalent to the claims.

### REFERENCE SIGNS LIST

1 Traveling body, 1a Crawler track device, 2 Rotating body, 2a Cab, 3 Work implement, 3a Boom, 3b Arm, 3c Bucket, 4 Hydraulic cylinder, 4a Boom cylinder, 4b Arm cylinder, 4c Bucket cylinder, 5c Arm top pin, 7a, 7b, 7c Stroke sensor, 8a, 8b, 8c, 8d IMU, 9a, 9b, 9c Angle sensor, 21 Engine, 22 Hydraulic pump, 23 Hydraulic oil tank, 28 Oil amount sensor, 30 Controller, 41 Cylinder tube, 42 Rod, 43 Piston, 60 Monitor, 61 Message icon, 62 Work machine icon, 63 Guidance icon, 64 Arrow icon, 65 Voice notification, 100 Hydraulic excavator, 301 Vehicle body attitude detection unit, 302 Vehicle body attitude determination unit, 303 Work implement attitude detection unit, 304 Work implement attitude determination unit, 305 Hydraulic oil amount determination unit, 306 Output unit, 307 Memory, GL Ground, OL Hydraulic oil, RD Reference distance, S Oil level, SE1, SE2 Stroke end, T1, T2, T3 Tolerance.

1. A work machine comprising:
a vehicle body;
a work implement supported by the vehicle body;
a detection device that detects at least any one of an attitude of the vehicle body and an attitude of the work implement; and
a controller that executes a comparison in at least any one of the vehicle body and the work implement between a current attitude detected by the detection device and a target attitude at a time of maintenance set in advance, and outputs a result of the comparison.

2. The work machine according to claim 1 further comprising
a monitor that displays information, wherein
the controller displays, on the monitor, a result of the comparison between the current attitude and the target attitude.

3. The work machine according to claim 2, wherein the controller displays, on the monitor, an outline in the current attitude and an outline when assuming the target attitude of at least any one of the vehicle body and the work implement.

4. The work machine according to claim 1, wherein the controller outputs guidance for reducing a difference when the difference between the current attitude and the target attitude is larger than a determination value.

5. The work machine according to claim 1, wherein the detection device detects the current attitude at a time of a stop operation of the work machine.

6. The work machine according to claim 5, wherein the controller outputs advice information regarding the target attitude of at least any one of the vehicle body and the work implement at the time of the stop operation of the work machine.

7. The work machine according to claim 1, wherein
the work implement includes a boom coupled to the vehicle body, an arm coupled to the boom, and a bucket coupled to the arm, and
the detection device detects a position of a distal end portion of the arm with respect to a ground on which the vehicle body is placed.

8. The work machine according to claim 7, wherein
the work machine further includes an arm cylinder that operates the arm and a bucket cylinder that operates the bucket, and
the detection device detects whether the arm cylinder is at a stroke end, and detects whether the bucket cylinder is at a stroke end.

9. The work machine according to claim 1, wherein the detection device includes a tilt sensor that is attached to the vehicle body and detects a tilt of the vehicle body.

10. The work machine according to claim 9, wherein the controller outputs the tilt of the vehicle body with respect to a horizon.

11. The work machine according to claim 1 further comprising:
a hydraulic oil tank that stores hydraulic oil to be supplied to the work implement; and
an oil amount sensor that detects a storage amount of the hydraulic oil in the hydraulic oil tank, wherein
when a difference between the current attitude and the target attitude is smaller than a determination value, the controller executes confirmation as to whether the storage amount, of the hydraulic oil, that is current and detected by the oil amount sensor is appropriate, and outputs a result of the confirmation.

12. A method for inspecting a storage amount of hydraulic oil to be supplied to a work implement in a hydraulic oil tank that stores the hydraulic oil, the method for inspecting a hydraulic oil amount comprising:
acquiring a current attitude of the work implement;
executing a comparison in the work implement between the current attitude and a target attitude at a time of inspection set in advance;
when a difference between the current attitude and the target attitude is smaller than a determination value, confirming as to whether the storage amount, of the hydraulic oil, that is current is appropriate; and
outputting a result of the confirmation.
